(19) United States
(12) Patent Application Publication
(10) Pub. No.: US 2011/0129755 A1
(43) Pub. Date: Jun. 2, 2011

(54) Power Supply Device and Pressure Regulator

(76) Inventor: Terumasa Nagasaki, Tokyo (JP)

(21) Appl. No.: 12/819,727

(22) Filed: Jun. 21, 2010

(30) Foreign Application Priority Data
Nov. 27, 2009 (JP) 2009-270537

(51) Int. Cl. H01M 8/04; F15D 1/02

(52) U.S. Cl. 429/447; 137/38

(57) ABSTRACT

According to one embodiment, a power supply device includes a fuel cell, a pipe passage, a fuel pump, a component, a tilt sensor, a pressure regulator, a pressure calculator, and a pressure controller. The fuel cell generates electric power using liquid fuel. The pipe passage supplies the liquid fuel to the fuel cell. The fuel pump sends the liquid fuel to the pipe passage. The component is located in the pipe passage. The tilt sensor detects a tilt angle of the component. The pressure regulator regulates the pressure of the liquid fuel applied to the component. The pressure calculator calculates a variation in the pressure of the liquid fuel applied to the component based on the distance between the component and the pressure regulator and the tilt angle. The pressure controller controls the pressure regulator to maintain the pressure applied to the component within an allowable pressure range.

### CROSS-REFERENCE TO RELATED APPLICATIONS

This application is based upon and claims the benefit of priority from Japanese Patent Application No. 2009-270537, filed Nov. 27, 2009, the entire contents of which are incorporated herein by reference.

### FIELD

Embodiments described herein relate generally to a power supply device and a pressure regulator.

### BACKGROUND

In recent years, fuel cells have been developed as power supply devices for mobile electronic devices such as mobile phones, personal computers (PCs), and personal digital assistants (PDAs). The fuel cell generates electric power by a chemical reaction between hydrogen and oxygen. The fuel cell is supplied with fuel such as methanol or other hydrocarbon fuels to generate electric power using an electrochemical reaction between hydrogen from the fuel and oxygen from the air. That is, differently from secondary batteries such as lithium ion batteries, the fuel cell does not need to be recharged from a wall socket and can generate electric power even in the outdoors or the public transports if supplied with fuel. This eliminates the worry of running out of battery.

Hydrogen gas, ethanol containing hydrogen, hydrocarbon liquid fuel such as methanol can be used as the fuel for the fuel cell. Compared to fuel gas, liquid fuel is easily obtained and used to replenish the fuel cell, and also, a spare of the fuel cartridge is easily carried around. In view of this, the fuel cell for the mobile electronic devices generally generates electric power using liquid fuel.

The fuel cell using liquid fuel is provided with a flow channel to supply fuel from the fuel tank to the cell power generator that generates electric power. In addition, such a fuel cell requires another flow channel to be provided on the output side of the cell power generator to collect unreacted fuel, water generated by reaction, and the like.

It is often the case that the mobile electronic device is used while held with the hand or placed on an inclined surface. Therefore, it is necessary to prevent liquid fuel from leaking out of the flow channel or other parts when the mobile electronic device is tilted. Besides, even when the mobile electronic device is tilted, it is required that the functions, such as those for fuel supply from the fuel tank, electric power generation by the cell power generator, and smooth flow of liquid fuel, operate normally and securely.

For example, Japanese Patent Application Publication (KOKAI) No. 2004-146371 discloses a conventional fuel cell system that is provided with a tilt sensor. When a fuel cell unit is tilted, a second valve, which opens/closes the fuel cell unit, is closed to prevent fuel from leaking to the outside.

In the conventional fuel cell system, the valve is closed when a tilt is detected. Therefore, electric power generation is stopped each time the mobile electronic device is tilted.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic block diagram of a fuel cell unit according to an embodiment;

FIG. 2 is an exemplary schematic diagram of a gas-liquid separator and a pressure regulator in the embodiment;

FIGS. 3A to 3C are exemplary schematic diagrams for explaining the liquid pressure applied to the gas-liquid separator and the operation state of the gas-liquid separator in the embodiment;

FIG. 4 is an exemplary schematic diagram for explaining the angle measurement axis of a tilt sensor, and the positional relation between the gas-liquid separator and the pressure regulator in the embodiment; and

FIG. 5 is an exemplary flowchart of a pressure regulation process performed by a controller in the embodiment.

### DETAILED DESCRIPTION

In general, according to one embodiment, a power supply device comprises a fuel cell, a pipe passage, a fuel pump, a component, a tilt sensor, a pressure regulator, a pressure calculator, and a pressure controller. The fuel cell is configured to generate electric power using liquid fuel. The pipe passage is configured to supply the liquid fuel from a fuel tank to the fuel cell. The fuel pump is configured to send the liquid fuel from the fuel tank to the pipe passage. The component is located in the pipe passage. The housing is configured to house the fuel cell, the pipe passage, the fuel pump, and the component. The tilt sensor is configured to detect a tilt angle of the component or the housing. The pressure regulator is configured to regulate the pressure of the liquid fuel applied to the component. The pressure calculator is configured to calculate a variation in the pressure of the liquid fuel applied to the component due to a tilt based on the distance between the component and the pressure regulator and the tilt angle detected by the tilt sensor. The pressure controller is configured to control the pressure regulator such that the pressure of the liquid fuel applied to the component after pressure variation due to the tilt is maintained within an allowable pressure range of the component.

According to another embodiment, a pressure regulator comprises a tilt angle detector, a pressure regulator, a pressure calculator, and a pressure controller. The tilt angle detector is configured to detect a tilt angle of a component located in a pipe passage through which a liquid flows. The pressure regulator is configured to regulate the pressure of the liquid applied to the component. The pressure calculator is configured to calculate a variation in the pressure of the liquid applied to the component due to a tilt based on the distance between the component and the pressure regulator and the tilt angle detected by the tilt angle detector. The pressure controller is configured to control the pressure regulator such that the pressure of the liquid applied to the component after pressure variation due to the tilt is maintained within an allowable pressure range of the component.

A power supply device according to an embodiment will be described as a fuel cell unit that supplies power to mobile electronic devices such as mobile phones, personal computers (PCs), and personal digital assistants (PDAs). A pressure regulator of the embodiment will be described as being comprised in the fuel cell unit and located in a liquid flow channel used for liquid fuel supply to regulate the pressure of liquid fuel in the flow channel.

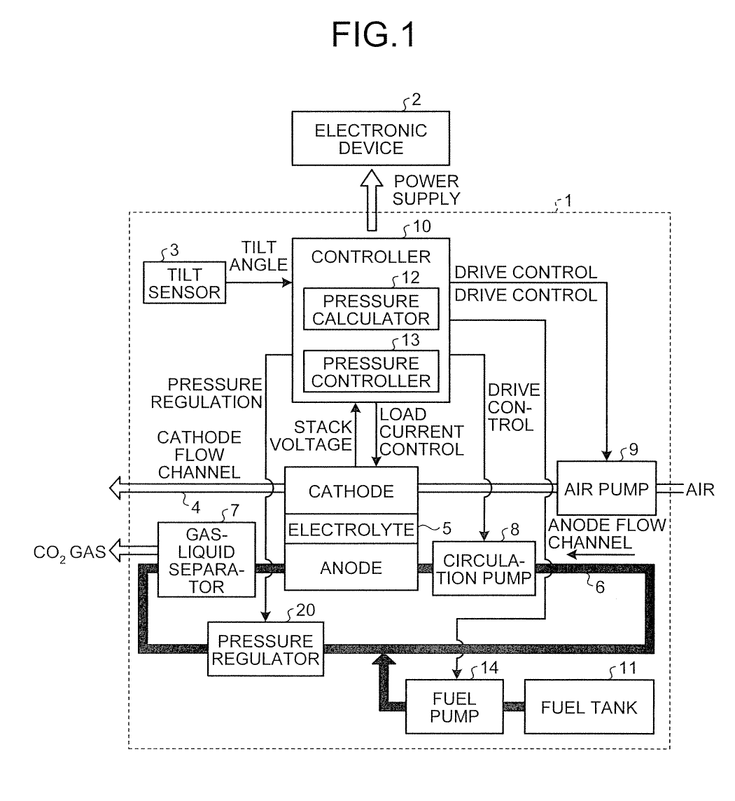

FIG. 1 is a block diagram of a fuel cell unit 1 according to the embodiment. The fuel cell unit 1 is a power generating unit comprising a fuel cell 5 that generates electric power using an electrochemical reaction between liquid fuel in a fuel tank (cartridge) 11 and oxygen from the air. The fuel cell unit 1 supplied the electric power generated by the fuel cell 5 to an electronic device 2 via a control circuit (not illustrated) of a controller 10. The electronic device 2 may be, for example, a notebook PC. The fuel cell unit 1 further comprises a gas-liquid separator 7, a pressure regulator 20, and a tilt sensor 3.

The fuel cell unit 1 is housed in a housing (not illustrated), and is connectable to the electronic device 2 through a connector provided to the housing. The housing is also provided with a power output terminal that is connected to a power input terminal of the electronic device 2 to supply electric power from the fuel cell unit 1 to the electronic device 2.

The fuel cell 5 comprises a fuel pole (anode), an air pole (cathode), and a solid polyelectrolyte. The air pole supplies the air as an oxidant for fuel. The solid polyelectrolyte is located between the poles. The reaction between hydrogen from the fuel and oxygen from the air generates electric power to be supplied to an external load. While the fuel cell 5 comprises layers of a combination of the anode, the cathode, and the solid polyelectrolyte to generate sufficient boot power to be supplied to the electronic device 2, FIG. 1 schematically illustrates the configuration in a simplified manner.

The fuel cell unit 1 of the embodiment employs a direct methanol fuel cell (DMFC) as the fuel cell 5 that directly supplies methanol as fuel to the anode. Further the fuel cell unit 1 employs a dilution circulation system in which high concentration methanol is diluted with water produced as a reactive product to a level increasing the power generation efficiency, and diluted low concentration methanol is supplied to the fuel cell 5. With this, a cartridge filled with filled with high concentration methanol can be used as the fuel tank 11 and downsized.

As illustrated in FIG. 1, the fuel cell unit 1 further comprises a cathode flow channel 4 and an anode flow channel 6. The cathode flow channel 4 is a pipe passage to supply oxygen absorbed from the air to the air pole (cathode). Meanwhile, the anode flow channel 6 is a pipe passage to supply liquid fuel in the fuel tank 11 to the fuel pole (anode).

The air is drawn into the cathode flow channel 4 by an air pump 9 through a ventilation hole formed in an and of the cathode flow channel 4, and is then supplied to the cathode of the fuel cell 5. On the other hand, high concentration methanol in the fuel tank 11 is sent into the anode flow channel 6 by a fuel pump 14, and is then supplied to the anode of the fuel cell 5 by a circulation pump 8.

In the anode, hydrogen in the methanol is absorbed into the electrolyte as a hydrogen ion (proton). The proton moves to the cathode in the electrolyte having proton permeability. Having moved to the cathode, the proton bonds with oxygen in the air to form a water molecule and generate an electron, i.e., electric power.

Accordingly, in the cathode, water (vapor) is produced as a reactive product of the power generation reaction. The water is supplied if necessary to the anode flow channel 6 of the dilution circulation system so that the high concentration methanol supplied from the fuel tank 11 can be diluted into an aqueous methanol solution.

On the other hand, carbon dioxide gas is produced as a reactive product in the anode. The carbon dioxide gas flows into the anode flow channel 6 as gas-liquid mixture fluid together with unreacted methanol. The unreacted methanol may be circulated in the anode flow channel 6 and used again for the reaction in the anode. However, the carbon dioxide gas decreases the power generation efficiency, and is preferably removed. Therefore, the gas-liquid separator 7 is provided to the anode flow channel 6 at the downstream in the fuel cell 5 to separate carbon dioxide from the aqueous methanol solution.

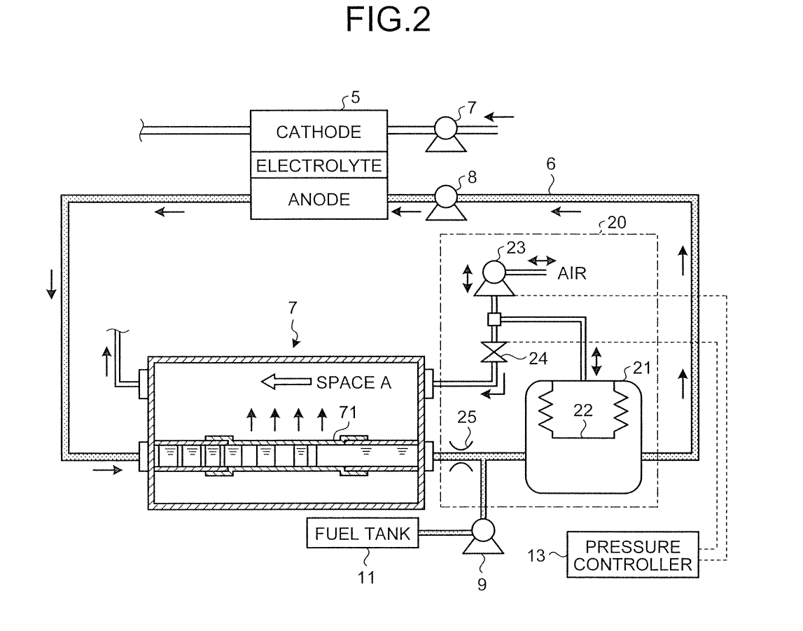

The gas-liquid separator 7 will be described with reference to FIG. 2. FIG. 2 schematically illustrates the configuration of the gas-liquid separator 7 and the pressure regulator 20. As illustrated in FIG. 2, the gas-liquid separator 7 comprises a gas-liquid separation tube 71 through which gas-liquid mixture fluid flows. Gas is discharged from the gas-liquid separation tube 71 to the outside so that the gas (carbon dioxide gas) can be separated from liquid (aqueous methanol solution). For example, as described in Japanese Patent Application Publication (KOKAI) No. 2008-210624, the gas-liquid separation tube 71 is made of a porous polymer film having gas permeability. As illustrated in FIG. 2, the carbon dioxide gas in the gas-liquid mixture fluid flowing through the gas-liquid separation tube 71 penetrates the porous polymer film and is discharged to a space A outside the gas-liquid separation tube 71. The space A is open to the air, and the pressure in the space corresponds to the atmospheric pressure.

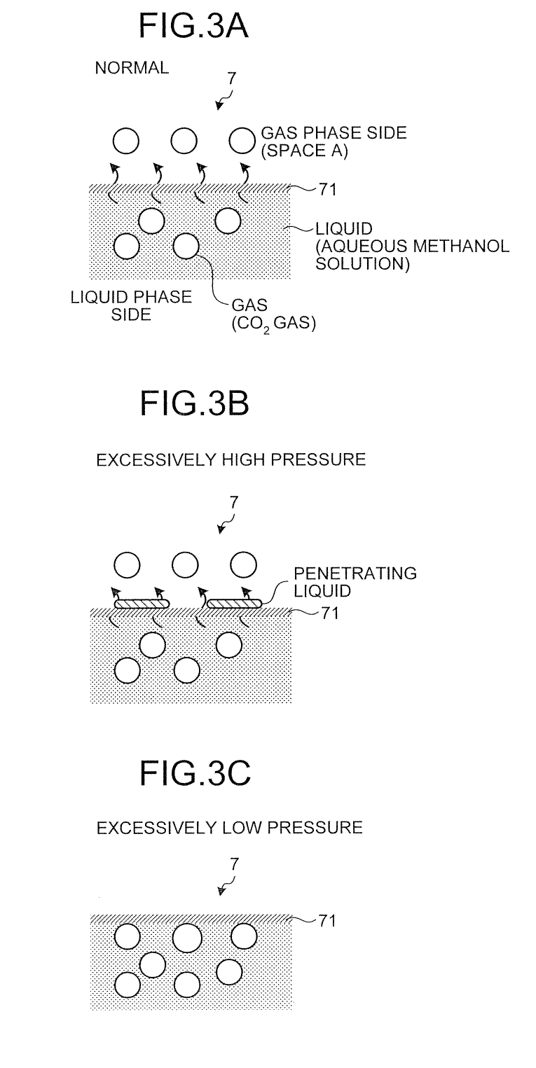

With reference to FIGS. 3A to 3C, a description will be given of the liquid pressure applied to the gas-liquid separator 7 and the operation state of the gas-liquid separator 7. FIGS. 3A to 3C are schematic diagrams for explaining the liquid pressure applied to the gas-liquid separator 7 and the operation state of the gas-liquid separator 7.

FIG. 3A illustrates the operation state of the gas-liquid separator 7 when the fuel cell unit 1 is placed horizontally and the pressure of the liquid in the gas-liquid separator 7 is normal. As illustrated in FIG. 3A, when the pressure of the liquid in the gas-liquid separator 7 applied to the gas-liquid separation tube 71 is within a normal range, the gas-liquid separator 7 functions normally. Depending on the difference between the pressure on the liquid phase side and that on the gas phase side (atmospheric pressure), gas in the gas-liquid mixture phase is discharged from the gas-liquid mixture fluid to the gas phase side, i.e., the space A, through the gas-liquid separation tube 71. It is assumed herein that, in the state where the gas-liquid separation tube 71 has no leakage and is permeable to carbon dioxide gas in the liquid phase to the space A with high gas-liquid separability, the liquid pressure applied to the gas-liquid separator 7 is within a normal range.

On the other hand, when the fuel cell unit 1 is tilted, a height difference is caused between the gas-liquid separator 7 and the pressure regulator 20. According to the height difference, hydraulic head pressure is generated at respective positions in the anode flow channel 6 that contain a liquid. Consequently, the hydraulic head pressure is applied to the gas-liquid separator 7 as a variation in the pressure of the liquid applied to the gas-liquid separator 7 due to the tilt.

For example, in FIG. 1, if the fuel cell unit 1 is tilted so that the pressure regulator 20 is located higher than the gas-liquid separator 7, the hydraulic head pressure is applied to the gas-liquid separator 7 located at a lower level according to the height difference between the gas-liquid separator 7 and the pressure regulator 20. In this case, as illustrated in FIG. 3B, the pressure of the liquid in the gas-liquid separation tube 71 increases. As a result, not only the carbon dioxide gas but also the aqueous methanol solution penetrates the gas-liquid separation tube 71, and liquid leakage occurs.

On the other hand, in FIG. 1, if the fuel cell unit 1 is tilted so that the pressure regulator 20 is located lower than the gas-liquid separator 7, the hydraulic head pressure is applied to the pressure regulator 20 located at a lower level according to the height difference between the gas-liquid separator and the pressure regulator 20. In other words, negative hydraulic head pressure is applied to the gas-liquid separator 7. In this case, as illustrated in FIG. 3C, the pressure of the liquid in the gas-liquid separation tube 71 decreases. Since the pressure difference is small between the liquid phase side and the gas phase side, the carbon dioxide gas cannot penetrate the gas-liquid separation tube 71. The gas-liquid separability of the gas-liquid separator 7 decreases, and thereby the power generation efficiency decreases due to unseparated carbon dioxide gas.

The pressure of the liquid applied to the gas-liquid separator 7 needs to be regulated to prevent liquid leakage in the gas-liquid separator 7 and the decrease of the power generation efficiency due to the low gas-liquid separability of the gas-liquid separator 7. Accordingly, the fuel cell unit 1 of the embodiment, when tilted, calculates hydraulic head pressure applied to the gas-liquid separator 7. The pressure regulator 20 regulates the pressure of the liquid applied to the gas-liquid separator 7 maintained within an allowable pressure range.

As illustrated in FIG. 2, the pressure regulator 20 is connected to the gas-liquid separator 7. The pressure regulator 20 comprises a buffer tank 21, a volume-variable container 22, a pump 23, and a valve 24. The buffer tank 21 contains a liquid. The volume-variable container 22 is located in the buffer tank 21 and may be, for example, a resin bellows, the volume of which varies depending on gas taken therein. The pump 23 is connected to the volume-variable container 22 to send gas (air) thereto.

As illustrated in FIG. 1, the fuel cell unit 1 comprises the tilt sensor 3 to detect the tilt angle of the components (for example, the gas-liquid separator 7 and the housing). When the fuel cell unit 1 is tilted, the tilt sensor 3 detects the tilt angle of the fuel cell unit 1 and the components thereof.

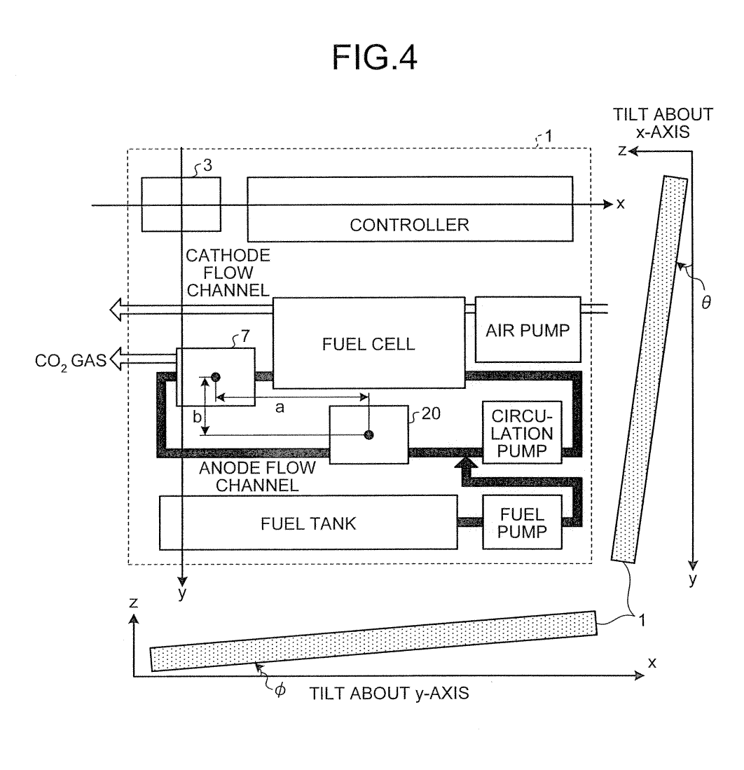

FIG. 4 is a schematic diagram for explaining the angle measurement axes, x-axis and y-axis, of the tilt sensor 3, and the positional relation between the gas-liquid separator 7 and the pressure regulator 20. In FIG. 4, the x-axis corresponds to the width direction of the housing, while the y-axis corresponds to the depth direction. As illustrated in FIG. 4, the tilt sensor 3 detects a tilt angle θ about the x-axis and a tilt angle φ about the y-axis with respect to the x-axis and the y-axis perpendicular to each other in the horizontal plane.

As illustrated in FIG. 4, the gas-liquid separator 7 and the pressure regulator 20 are arranged not in parallel to each other with respect to the x-axis or the y-axis. In other words, the gas-liquid separator 7 and the pressure regulator 20 are arranged such that distance a in the x-axis direction and distance b in the y-axis direction between the gas-liquid separator 7 and the pressure regulator 20 are larger than zero. This is because, for example, if the gas-liquid separator 7 and the pressure regulator 20 are arranged in parallel to each other with respect to the x-axis in FIG. 4 (placed at the same y-coordinates), the distance b in the y-axis direction between the gas-liquid separator 7 and the pressure regulator 20 is zero (b=0). Accordingly, when the fuel cell unit 1 is tilted about the x-axis, the height difference is not generated between the gas-liquid separator 7 and the pressure regulator 20, and it becomes useless to measure a tilt angle about the x-axis.

The controller 10 comprises an integrated circuit (IC) chip such as a system control microcomputer unit (MCU), and controls the entire system of the fuel cell unit 1. The controller 10 controls the driving of each pump, power supply to the electronic device 2, and the like to control electric power generation by the fuel cell unit 1. The memory area of the circuit that constitutes the controller 10 stores the distance a in the x-axis direction and the distance b in the y-axis direction between the gas-liquid separator 7 and the pressure regulator 20 (see FIG. 4). As illustrated in FIG. 1, the controller 10 comprises a pressure calculator 12 and a pressure controller 13.

The pressure calculator 12 calculates height difference h between the gas-liquid separator 7 and the pressure regular 20 cased by the tilt of the fuel cell unit 1 and hydraulic head pressure ΔP applied to the gas-liquid separator 7 based on the distances a and b between the gas-liquid separator 7 and the pressure regulator 20 read from the memory area of the circuit, and the tilt angle θ about the x-axis and the tilt angle φ about the y-axis of the fuel cell unit 1 detected by the tilt sensor 3.

The height difference h [cm] between the gas-liquid separator 7 and the pressure regulator 20 can be represented by the distances a and b between the gas-liquid separator 7 and the pressure regulator 20, and the tilt angles θ [deg] and φ [deg] detected by the tilt sensor 3 as the following equation:

h=a·sin θ+b·sin φ (1)

The hydraulic head pressure generally changes by about 1.0 kPa due to the height difference of 10 cm. Therefore, based on the height difference h [cm] calculated using Equation 1, the hydraulic head pressure ΔP [kPa] can be obtained by the following equation:

P=h/10 [kPa] (2)

The pressure calculator 12 calculates the height difference h using Equation 1, and calculates the hydraulic head pressure ΔP using Equation 2.

The pressure controller 13 controls the pressure regulator 20 so that when the hydraulic head pressure ΔP is applied to the gas-liquid separation tube 71, the pressure of the liquid applied to the gas-liquid separator 7 is maintained within an allowable pressure range in which the gas-liquid separator 7 operates normally based on the hydraulic head pressure ΔP between the gas-liquid separator 7 and the pressure regulator 20 calculated by the pressure calculator 12.

More specifically, the pressure controller 13 controls the pressure regulator 20 to regulate pressure Preg of the liquid applied to the gas-liquid separator 7 to satisfy the following relation:

Pmin<Preg+ΔP<Pmax

where Pmin is the minimum pressure that allows the gas-liquid separator 7 to operate normally, and Pmax is the maximum pressure that allows the gas-liquid separator 7 to operate normally.

For example, if the fuel cell unit 1 is tilted so that the gas-liquid separator 7 is located higher than the pressure regulator 20, the pressure controller 13 controls the pressure regulator 20 to increase the pressure Preg of the liquid applied to the gas-liquid separator 7. On the other hand, if the fuel cell unit 1 is tilted so that the gas-liquid separator 7 is located lower than the pressure regulator 20, the pressure controller 13 controls the pressure regulator 20 to reduce the pressure Preg of the liquid applied to the gas-liquid separator 7.

The pressure controller 13 closes the valve 24 and reverses the pump 23 to discharge the air from the volume-variable container 22. In this manner, the pressure controller 13 reduces the volume of the volume-variable container 22 so that the buffer tank 21 can contain more liquid. Since the anode flow channel 6 has a closed-loop configuration, as the volume-variable container 22 contracts, the pressure decreases in the buffer tank 21. Accordingly, the liquid in the gas-liquid separation tube 71 is drawn into the buffer tank 21, and the pressure of the liquid applied to the gas-liquid separation tube 71 decreases.

On the other hand, the pressure controller 13 opens the valve 24 and positively rotates the pump 23 to draw the air into the volume-variable container 22. In this manner, the pressure controller 13 increases the volume of the volume-variable container 22 so that the buffer tank 21 can contain less liquid. As the volume-variable container 22 is swollen, the pressure increases in the buffer tank 21. Accordingly, the liquid in the buffer tank 21 is drawn into the gas-liquid separation tube 71, and the pressure of the liquid applied to the gas-liquid separation tube 71 increases. Thus, the pressure controller 13 controls the pressure of the liquid (aqueous methanol solution) applied to the gas-liquid separation tube 71 of the gas-liquid separator 7.

As illustrated in FIG. 2, the pressure regulator 20 may comprises a pressure reducer such as a pressure reducer valve 25 to control the pressure of the liquid applied to the gas-liquid separation tube 71. In this case, the pressure controller 13 adjusts the opening of the pressure reducer valve 25 to control the amount of liquid flowing from the gas-liquid separation tube 71 to the buffer tank 21. The pressure controller 13 may control the pressure by a combination of pressure control using the pump 23 and the valve 24 described above and pressure control using the pressure reducer valve 25.

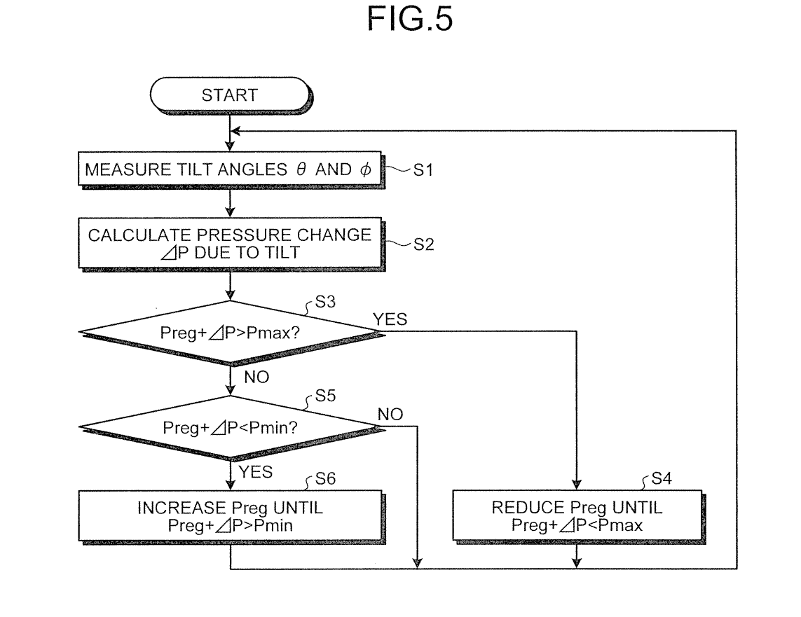

with reference to FIG. 5, a description will be given of a pressure regulation process performed in the fuel cell unit 1. FIG. 5 is a flowchart of the pressure regulation process performed by the controller 10 of the embodiment.

First, the sensor 3 detects the tilt angle θ about the x-axis and the tilt angle φ about the y-axis (S1). Then, the pressure calculator 12 calculates the height difference h between the gas-liquid separator 7 and the pressure regulator 20 and the hydraulic head pressure ΔP based on the distances a and b between the gas-liquid separator 7 and the pressure regulator 20 and the tilt angles θ and φ detected by the tilt sensor 3 using Equations 1 and 2 (S2).

The pressure controller 13 controls the pressure Preg of the liquid applied to the gas-liquid separator 7 so that the pressure applied to the gas-liquid separator 7 is maintained within an allowable pressure range even if the hydraulic head pressure ΔP is applied thereto, i.e., so that the relation Pmin<Preg+ΔP<Pmax is satisfied (S3 to S6). More specifically, when Preg+ΔP>Pmax (Yes at S3), the pressure controller 13 reduces the pressure Preg of the liquid applied to the gas-liquid separator 7 until the relation preg+ΔP<pmax is satisfied (S4).

On the other hand, if the pressure Preg+the hydraulic head pressure ΔP is not more than the maximum pressure Pmax (No at S3), the pressure controller 13 determines whether Preg+ΔP<Pmin (S5). When Preg+ΔP<Pmin (Yes at S5), the pressure controller 13 increases the pressure Preg of the liquid applied to the gas-liquid separator 7 until the relation preg+ΔP>pmin is satisfied (S6). If the pressure Preg+the hydraulic head pressure ΔP is not less than the minimum pressure Pmin (No at S5), the pressure controller 13 does not change the pressure Preg of the liquid applied to the gas-liquid separator 7 and, returning to S1, repeats the process from S1 to S6.

As described above, according to the embodiment, even when tilted, the fuel cell unit 1 can prevent liquid leakage by regulating the pressure in the flow channel without terminating electric power generation.

While the fuel cell unit 1 is described above as regulating the pressure Preg of the liquid applied to the gas-liquid separator 7, it is not so limited. The fuel cell unit 1 may regulate the pressure of the liquid applied to other components in the anode flow channel 6. With this, a component with a narrow allowable pressure range can be used in the anode flow channel 6, which contributes to the downsizing of the fuel cell unit 1 and the cost reduction.

While the liquid fuel is described above by way example as methanol, it is not so limited. The fuel cell unit 1 may use other fuels to generate electric power.

In the embodiment described above, when the fuel cell unit 1 is tilted, the pressure of fuel in the anode flow channel 6 is regulated. However, the embodiment is not so limited. The configuration described above may be applied to other reactors or burners and the pressure applied to components in the flow channel may be regulated to thereby reduce the influence of the hydraulic head pressure caused by a tilt.

A flow volume controller such as a valve or a mass flow controller may be provided between the fuel pump 14 and the anode flow channel 6 to control the flow volume of the liquid. In this case, the pressure controller 13 controls the flow volume of the liquid fuel flowing from the fuel tank 11 to the anode flow channel 6 to regulate the pressure of the liquid applied to the gas-liquid separator 7. Besides, the pressure controller 13 may control the operating rate of the fuel pump 14 to control the flow volume of the liquid fuel flowing from the fuel tank 11 to the anode flow channel 6.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply device comprising:
a fuel cell configured to generate electric power using liquid fuel;
a pipe passage configured to supply the liquid fuel from a fuel tank to the fuel cell;
a fuel pump configured to send the liquid fuel from the fuel tank to the pipe passage;
a component located in the pipe passage;
a housing configured to house the fuel cell, the pipe passage, the fuel pump, and the component;
a tilt sensor configured to detect a tilt angle of the component or the housing:
a pressure regulator configured to regulate pressure of the liquid fuel applied to the component;
a pressure calculator configured to calculate a variation in the pressure of the liquid fuel applied to the component due to a tilt based on a distance between the component and the pressure regulator and the tilt angle detected by the tilt sensor; and
a pressure controller configured to control the pressure regulator such that pressure of the liquid fuel applied to the component after pressure variation due to the tilt is maintained within an allowable pressure range of the component.

2. The power supply device of claim 1, wherein the tilt sensor is configured to detect the tilt angle in a width direction and a depth direction of the housing.

3. The power supply device of claim 1, wherein the distance between the component and the pressure regulator is larger than zero in the width direction and the depth direction.

4. The power supply device of claim 1, wherein the pressure calculator is configured to calculate a height difference caused between the component and the pressure regulator due to the tilt based on the distance between the component and the pressure regulator in the width direction and the depth direction and the tilt angle detected by the tilt sensor, and calculate the variation in the pressure of the liquid fuel applied to the component due to the tilt based on the height difference.

5. The power supply device of claim 1, wherein the pressure calculator is configured to calculate hydraulic head pressure between the component and the pressure regulator as the variation in the pressure of the liquid fuel applied to the component due to the tilt.

6. The power supply device of claim 1, wherein
when the component is tilted and is located higher than the pressure regulator, the pressure controller controls the pressure regulator to increase the pressure of the liquid fuel applied to the component, and
when the component is tilted and is located lower than the pressure regulator, the pressure controller controls the pressure regulator to reduce the pressure of the liquid fuel applied to the component.

7. The power supply device of claim 1, wherein
the component is a gas-liquid separator configured separate gas from the liquid fuel,
the pressure regulator comprising
a buffer tank configured to be connected to the gas-liquid separator and contain the liquid fuel,
a volume-variable container located in the buffer tank, a volume of the volume-variable container being variable depending on air taken in the volume-variable container, and
a pump configured to be connected to the volume-variable container to send the air to the volume-variable container, and
the pressure controller is configured to control pressure of the air that the pump sends to the volume-variable container to control the volume of the volume-variable container and a volume of the buffer tank except the volume-variable container, and change inner pressure of the liquid fuel contained in the buffer tank to regulate the pressure of the liquid fuel applied to the gas-liquid separator.

8. The power supply device of claim 7, wherein the pressure regulator comprising a pressure reducer between the gas-liquid separator and the buffer tank to reduce the pressure of the liquid fuel.

9. The power supply device of claim 1, wherein
the pressure regulator comprising a flow volume controller configured to control a flow volume of the liquid fuel flowing from the fuel tank to the pipe passage, and
the pressure controller is configured to control at least one of the fuel pump and the flow volume controller to control the flow volume of the liquid fuel flowing from the fuel tank to the pipe passage to regulate the pressure of the liquid fuel applied to the component.

10. A pressure regulator comprising:
a tilt angle detector configured to detect a tilt angle of a component located in a pipe passage through which a liquid flows;
a pressure regulator configured to regulate pressure of the liquid applied to the component;
a pressure calculator configured to calculate a variation in the pressure of the liquid applied to the component due to a tilt based on a distance between the component and the pressure regulator and the tilt angle detected by the tilt angle detector; and
a pressure controller configured to control the pressure regulator such that pressure of the liquid applied to the component after pressure variation due to the tilt is maintained within an allowable pressure range of the component.
